(19) United States
(12) Patent Application Publication
(10) Pub. No.: US 2018/0268039 A1
(43) Pub. Date: Sep. 20, 2018

(54) Recommending Car/Passenger Resources for User According to Mobility Habits

(71) Applicant: Bayerische Motoren Werke Aktiengesellschaft, Muenchen (DE)

(72) Inventors: Dominik Gusenbauer, Seattle, WA (US); Carsten Isert, Muenchen (DE); Andy Liao, Shanghai (CN); Lu Chen, Shanghai (CN); Michael Karg, Eching (DE)

(21) Appl. No.: 15/984,687

(22) Filed: May 21, 2018

Related U.S. Application Data
(63) Continuation of application No. PCT/CN2015/095732, filed on Nov. 27, 2015.

(51) Int. Cl. G06F 17/30

(52) U.S. Cl. CPC G06F 17/30554; G06F 17/30528; G06F 17/30598

(57) ABSTRACT

A computer implemented method for recommending car/passenger resources for a user includes extracting a trip including a start and a destination from location data of the user, wherein paths with the same start and the same destination are clustered into one trip, and generating time information corresponding to the trip, according to time data corresponding to the paths clustered into the trip, wherein the time information includes a range of departure time. The method includes calculating a frequency of occurrences for one trip within a predetermined time period as a habit value of the trip for the user. The trip, including the start and the destination, the time information corresponding to the trip, the habit value of the trip, and transport modality information indicating the user as a driver or a passenger, are combined to generate mobility habit data for the user.

### CROSS REFERENCE TO RELATED APPLICATIONS

This application is a continuation of PCT International Application No. PCT/CN2015/095732, filed Nov. 27, 2015, the entire disclosures of which is herein expressly incorporated by reference.

### BACKGROUND AND SUMMARY OF THE INVENTION

The present disclosure relates in general to ride sharing, and in more particular, to recommending car/passenger resources for a user according to mobility habits.

With the progress of urbanization, there is a growing number of inhabitants living in inner and outer areas of cities. This leads to an increasing volume of traffic in the above-mentioned areas. Accordingly, ride sharing technologies are increasingly developed to reduce the number of cars per person, thus to reduce energy consumption and to protect the environments.

In an existing ride sharing system, a driver offers his car for a particular trip, and a passenger submits a riding requirement for a particular trip, thereby the car driver gets an opportunity to make free seating capacity available for people who wanted to travel the same route.

However, in most time, an optimal matching cannot be obtained between the driver and the passenger, so some car/passenger resources are wasted. In addition, for the arrangement of a start, a destination, and departure time, it is necessary for a user to manually input personal data into the ride sharing system. Further, most of current ride sharing services provide journeys for long distances such as at least 80 kilometers. A system for ride sharing services of short distances is expected.

The present disclosure aims to provide new and improved methods and systems for recommending car/passenger resources for a user according to mobility habits.

In accordance with one aspect of the present disclosure, there is provided a computer implemented method for generating mobility habit data for a user, comprising: extracting a trip including a start and a destination from location data of the user, wherein paths with the same start and the same destination are clustered into one trip; generating time information corresponding to the trip, according to time data corresponding to the paths clustered into the trip, wherein the time information includes a range of departure time; and calculating a frequency of occurrences for one trip within a predetermined time period as a habit value of the trip for the user, wherein the trip including the start and the destination, the time information corresponding to the trip, the habit value of the trip, and transport modality information indicating the user as a driver or a passenger are used together as the mobility habit data for the user.

In accordance with another aspect of the present disclosure, there is provided a computer implemented method for recommending car resources for a user as a passenger according to mobility habits for the user, comprising: acquiring mobility habit data for users generated according to the first exemplary embodiment of the present disclosure; receiving a riding requirement from the user as the passenger, wherein the riding requirement includes a start, a destination and a departure time; searching, from mobility habit data for users as a driver, trips which match the riding requirement and have habit values above a first threshold as target trips, according to the received riding requirement; sending the riding requirement to users as the driver related to the target trips; and recommending the users as the driver to the user as the passenger after confirmation information is received from the users as the driver.

In accordance with a still another aspect of the present disclosure, there is provided a computer implemented method for recommending passenger resources for a user as a driver according to mobility habits for the user, comprising: acquiring mobility habit data for users generated according to the first exemplary embodiment of the present disclosure; receiving car offering information from the user as the driver, wherein the car offering information includes a start, a destination and a departure time; searching, from mobility habit data for users as a passenger, trips which matches the car offering information and have habit values above a first threshold as target trips, according to the received car offering information; sending the car offering information to users as the passenger related to the target trips; and recommending the users as the passenger to the user as the driver after confirmation information is received from the users as the passenger.

In accordance with a still another aspect of the present disclosure, there is provided a computer program product for generating mobility habit data for a user, the computer program product comprising a non-transitory computer readable medium having instructions stored thereon for, which, when executed by a processor, causing the processor to perform operations comprising: extracting a trip including a start and a destination from location data of the user, wherein paths with the same start and the same destination are clustered into one trip; generating time information corresponding to the trip, according to time data corresponding to the paths clustered into the trip, wherein the time information includes a range of departure time; and calculating a frequency of occurrences for one trip within a predetermined time period as a habit value of the trip for the user, wherein the trip including the start and the destination, the time information corresponding to the trip, the habit value of the trip, and transport modality information indicating the user as a driver or a passenger are used together as the mobility habit data for the user.

In accordance with a still another aspect of the present disclosure, there is provided a computer program product for recommending car resources for a user as a passenger according to mobility habits for the user, the computer program product comprising a non-transitory computer readable medium having instructions stored thereon for, which, when executed by a processor, causing the processor to perform operations comprising: acquiring mobility habit data for users generated according to the fourth exemplary embodiment of the present disclosure; receiving a riding requirement from the user as the passenger, wherein the riding requirement includes a start, a destination and a departure time; searching, from mobility habit data for users as the driver, trips which match the riding requirement and have habit values above a first threshold as target trips, according to the received riding requirement; sending the riding requirement to users as the driver related to the target trips; and recommending the users as the driver to the user as the passenger after confirmation information is received from the users as the driver.

In accordance with a still another aspect of the present disclosure, there is provided a computer program product for recommending passenger resources for a user as a driver according to mobility habits for the user, the computer program product comprising a non-transitory computer readable medium having instructions stored thereon for, which, when executed by a processor, causing the processor to perform operations comprising: acquiring mobility habit data for users generated according to the fourth exemplary embodiment; receiving car offering information of the user as the driver, wherein the car offering information includes a start, a destination and a departure time; searching, from mobility habit data for users as a passenger, trips which match the car offering information and have habit values above a first threshold as target trips, according to the received car offering information; sending the car offering information to users as the passenger related to the target trips; and recommending the users as the passenger to the user as the driver after confirmation information is received from the users as the passenger.

In accordance with a still another aspect of the present disclosure, there is provided a device including a processor and a memory having instructions thereon, which, when executed by the processor, cause the processor to perform any one of the above mentioned methods.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a flowchart of a computer implemented method for generating mobility habit data for a user in accordance with an exemplary embodiment of the present disclosure.

FIGS. 2 (a) and (b) illustrate the mobility habit data generated in accordance with an exemplary embodiment of the present disclosure.

FIG. 3 illustrates a flowchart of a computer implemented method for recommending car resources for a user as a passenger according to mobility habits for the user in accordance with an exemplary embodiment of the present disclosure.

FIG. 4 illustrates a flowchart of a computer implemented method for recommending car resources for a user as a passenger according to mobility habits for the user in accordance with an exemplary embodiment of the present disclosure.

FIG. 5 illustrates a user interface of a riding requirement recommendation for a user as a passenger in accordance with an exemplary embodiment of the present disclosure.

FIG. 6 illustrates a flowchart of a computer implemented method for recommending car resources for a user as a passenger according to mobility habits for the user in accordance with an exemplary embodiment of the present disclosure.

FIG. 7 illustrates a flowchart of a computer implemented method for recommending passenger resources for a user as a driver according to mobility habits for the user in accordance with an exemplary embodiment of the present disclosure.

FIG. 8 illustrates a flowchart of a computer implemented method for recommending passenger resources for a user as a driver according to mobility habits for the user in accordance with an exemplary embodiment of the present disclosure.

FIG. 9 illustrates a user interface of a car offering information recommendation for a user as a driver in accordance with an exemplary embodiment of the present disclosure.

FIG. 10 illustrates a flowchart of a computer implemented method for recommending passenger resources for a user as a driver according to mobility habits for the user in accordance with an exemplary embodiment of the present disclosure.

FIG. 11 illustrates a functional block diagram of a system for generating mobility habit data for a user in accordance with an exemplary embodiment of the present disclosure.

FIG. 12 illustrates a functional block diagram of a system for recommending car resources for a user as a passenger according to mobility habits for the user in accordance with an exemplary embodiment of the present disclosure.

FIG. 13 illustrates a functional block diagram of a system for recommending passenger resources for a user as a driver according to mobility habits for the user in accordance with an exemplary embodiment of the present disclosure.

FIG. 14 illustrates a schematic system for recommending car/passenger resources for a user based on mobility habits for the user in accordance with an exemplary embodiment of the present disclosure.

FIG. 15 illustrates a general hardware environment where the present disclosure is applicable in accordance with an exemplary embodiment of the present disclosure.

### DETAILED DESCRIPTION OF THE DRAWINGS

In the following detailed description, numerous specific details are set forth to provide a thorough understanding of the described exemplary embodiments. It will be apparent, however, to one skilled in the art that the described embodiments can be practiced without some or all of these specific details. In other exemplary embodiments, well known structures or process steps have not been described in detail in order to avoid unnecessarily obscuring the concept of the present disclosure.

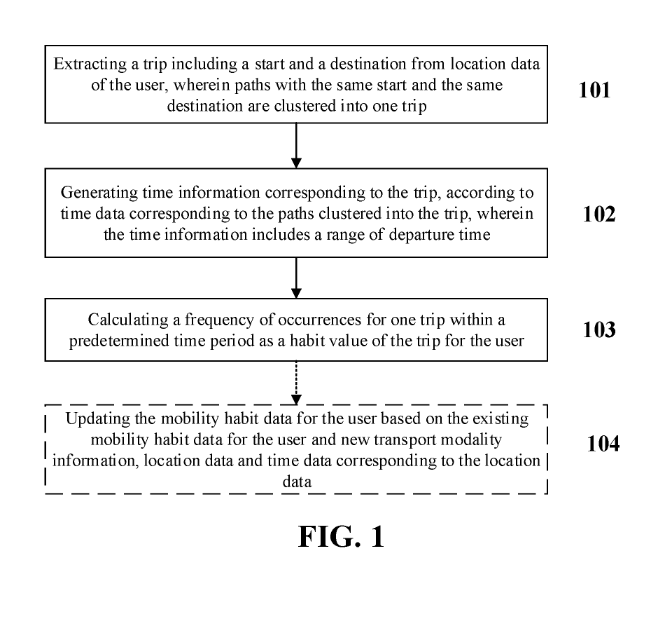

Referring to FIG. 1, there is illustrated a flowchart of a computer implemented method for generating mobility habit data for a user in accordance with an exemplary embodiment of the present disclosure.

As shown in FIG. 1, in step 101, a trip including a start and a destination is extracted from location data of the user, wherein paths with the same start and the same destination are clustered into one trip.

Location data may be the coordinate of the user. For example, the location data may include latitude data and longitude data of the user. The location data of a user may be received from a positioning system such as the Global Position System (GPS) used for measuring daily locations of the user. The positioning system may be implemented in a mobile phone, a tablet, a car, etc.

The location data may be classified into the points where a person is moving (moving points) and the points where the person is in a static state (stop points). The moving point and the stop point may be distinguished by a moving speed of the person. For example, if the moving speed of the person is low enough, that is, below a predefined threshold, such as below 1.5 km/h, the person may be regarded as being in a static state, and the current location data of the person may be classified into a stop point. The points not included in stops may be classified into moving points. The location data may be classified into the moving points and the stop points by the method for example, disclosed in A. T. Palma, V. Bogorny, B. Kuijpers, and L. O. Alvares, “A clustering based approach for discovering interesting places in trajectories,” in Proceedings of the 2008 ACM Symposium on Applied Computing, ser. SAC '08, 2008, pp. 863-868.

In the classified location data, two stop points and a plurality of moving points between the two stop points may be defined as a path, wherein one of the two stop points indicates a start of the path and the other indicates a destination of the path.

Assuming there are two paths with the same start and same destination, for example, one path may be from home to work through Road-A, and the other path may be from home to work through Road-B which is different from Road-A. Since the starts and destinations of the two paths are the same, in step 101, the two paths may be clustered into one trip including a start of “home” and a destination of “work”.

In one embodiment, two trips may be clustered into one trip if differences between the starts and the destinations of the two trips are within a predetermined range.

For example, one trip includes a Start-A and a Destination-B, and another trip includes a Start-A′ and a Destination-B′. If the distance between Start-A and Start-A′ is 80 meters which is within a predetermined range of 100 meters, for example, and the distance between Destination-B and Destination-B′ is 60 meters, which also within the predetermined range, these two trips may be clustered into one trip.

In some cases, the localization measures are inaccurate, causing the acquired location data varying even when a person does not move. With this embodiment, if differences between the starts and the destinations of two trips are within a predetermined range, the two trips may be clustered into one trip. Therefore, the inaccuracy due to localization measures may be decreased.

Next, in step 102, time information corresponding to the trip is generated according to time data corresponding to the paths clustered into the trip, wherein the time information includes a range of departure time.

Time data may be a timestamp used for marking time of location data. Time data corresponding to one path may include the departure time of the path, that is, the timestamp of the location data corresponding to the start of the path. Since the departure time of paths clustered into one trip may be different, the time information corresponding to the trip may include a range of departure time determined by the departure time of the paths within the trip.

The range of departure time included in the time information may be defined as an average value of the departure time with a variance of the departure time. The average value of the departure time may be calculated by averaging the departure time of each path clustered into the trip, and the variance of the departure time may be estimated according to the departure time using a confidence level. For example, the Kernel Density Estimation in the prior art may be used to generate the range of departure time (see M. Rosenblatt et al., “Remarks on some nonparametric estimates of a density function”, The Annals of Mathematical Statistics, vol. 27, no. 3, pp. 832-837, 1956).

It is noted that the start and the destination may be the detailed position or the identification of the position. For example, Anechostrasse 66, Munich may be identified as Home, and Parkring 19, Garching may be identified as Work.

For example, assuming there are five paths clustered into one trip with the same start of home and the same destination of work as shown in Table 1. The average value of departure time is calculated as 08:07 am, and the variance of departure time may be estimated as 50 min. Therefore, the range of departure time may be 08:07 am±50 min. Further, since the departure time of Path E is deviated from the range of departure time of the trip from home to work, Path E may be removed from the trip.

TABLE 1
Paths with the same start and the same destination

| | | |
|---|---|---|
| Path A | Home→Work | 07:45 am |
| Path B | Home→Work | 07:53 am |
| Path C | Home→Work | 08:01 am |
| Path D | Home→Work | 07:21 am |
| Path E | Home→Work | 09:37 am |

Next, in step 103, a frequency of occurrences for one trip within a predetermined time period is calculated as a habit value of the trip for the user. For example, if a person traveled from the Work to a gym on six out of ten days, the habit value for this trip would be 6/10=0.6.

In one embodiment, the predetermined time period may be only calculated for workdays or holidays. Since the regularity of most persons' mobility strongly varies depending on the current day being a workday or a holiday, it is possible to make the calculated habit value conform with the user's actual habit more accurate by using the predetermined time period only calculated for workdays or holidays.

The trip including the start and the destination, the time information corresponding to the trip, the habit value of the trip, and transport modality information indicating the user as a driver or a passenger may be used together as the mobility habit data for the user.

Therefore, the mobility habit data for a user may be used for recommending car/passenger resources for the user. Embodiments of recommending car/passenger resources for a user according to mobility habits for the user will be explained later.

In one embodiment, the computer implemented method for generating mobility habit data for a user as shown in FIG. 1 may further comprise a further updating step. As shown in FIG. 1, in step 104, the mobility habit data for the user is updated based on the existing mobility habit data for the user and new transport modality information, location data and time data corresponding to the location data.

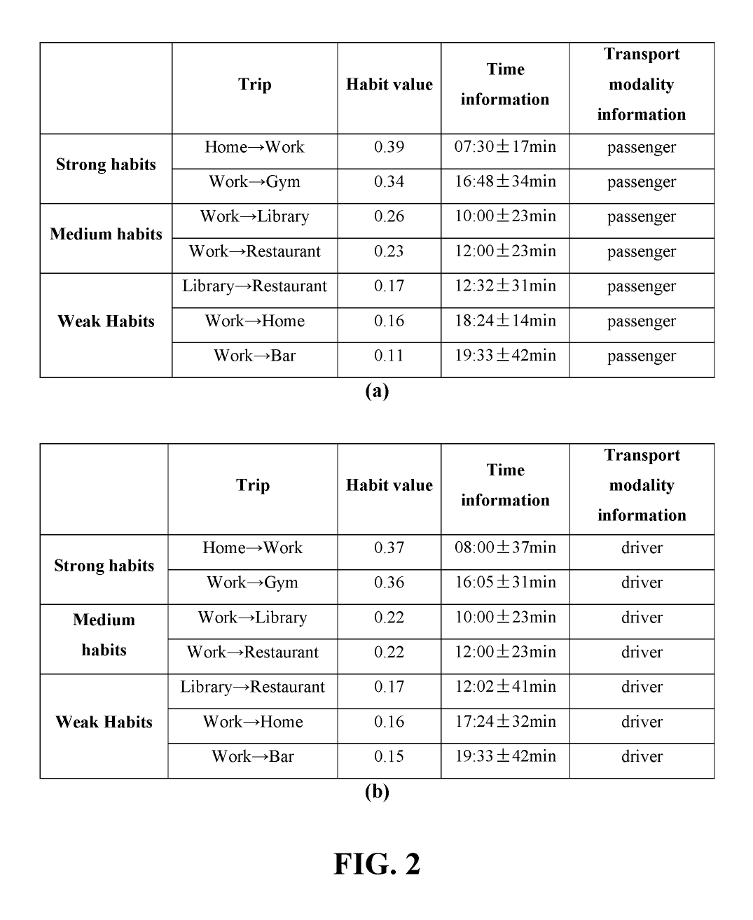

Referring now to FIGS. 2 (a) and (b), some examples of the mobility habit data generated in accordance with an exemplary embodiment of the present disclosure is illustrated, wherein (a) shows mobility habit data for a user as a passenger and (b) shows mobility habit data for a user as a driver.

In one embodiment, as illustrated in FIGS. 2 (a) and (b), the mobility habit data for a user may comprise a trip including a start and a destination, a habit value of the trip, time information corresponding to the trip including a range of departure time, and transport modality information indicating the user as a driver or a passenger.

In one embodiment, the mobility habit data for the user may be grouped by the habit values of trips for the user. For example, as illustrated in FIGS. 2 (a) and (b), the mobility habit data is grouped into strong habits with habit values above a strong habit threshold, medium habits with habit values above a weak habit threshold and below the strong habit threshold, and weak habits with habit values below the weak habit threshold. The strong habit threshold is larger than the weak habit threshold. For example, as shown in FIGS. 2 (a) and (b), the strong habit threshold may be equal to 0.30 and the weak habit threshold may be equal to 0.20.

In one embodiment, the mobility habit data for the user may be further sorted by time information corresponding to trips for the user. For example, as illustrated in FIGS. 2 (a) and (b), the mobility habit data is sorted in chronological order.

It is noted that the start and the destination may be the detailed position or the identification of the position. For example, Anechostrasse 66, Munich may be identified as Home, and Parkring 19, Garching may be identified as Work.

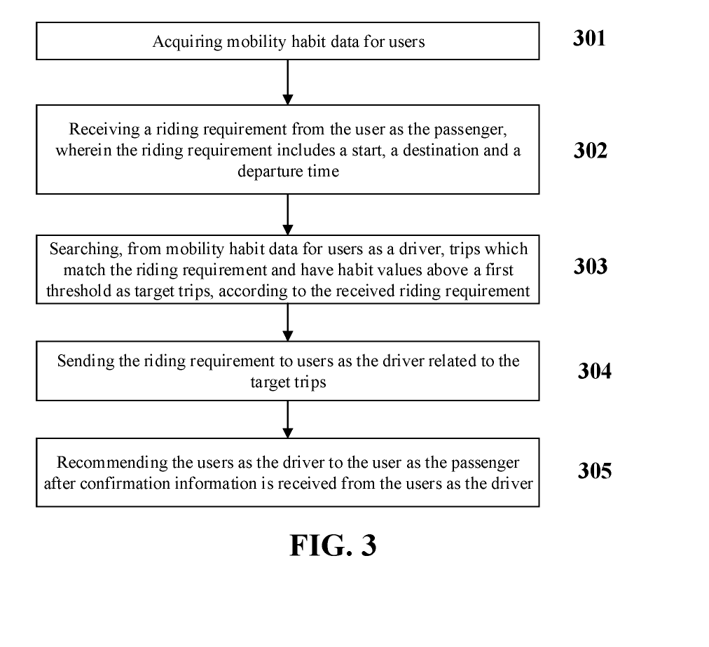

Referring now to FIG. 3, there is shown a flowchart of a computer implemented method for recommending car resources for a user as a passenger according to mobility habits for the user in accordance with an exemplary embodiment of the present disclosure.

As shown in FIG. 3, in step 301, the mobility habit data for users is acquired by using the computer implemented method for generating mobility habit data for a user in accordance with the aforementioned exemplary embodiments of the present disclosure. Mobility habit data for a user may comprise a trip including a start and a destination, time information corresponding to the trip, a habit value of the trip, and transport modality information indicating the user as a driver or a passenger, for example as illustrated in FIGS. 2 (a) and (b).

Next, in step 302, a riding requirement is received from the user as the passenger, wherein the riding requirement includes a start, a destination and a departure time. For example, the riding requirement of the user as the passenger may be “from work to gym at 16:30”. The riding requirement may be input by the user as the passenger according to his current or future riding conditions and sent via his mobile phone, tablet as well as other portable equipment, and so on.

Next, in step 303, according to the received riding requirement, trips which match the riding requirement and have habit values above a first threshold are searched as target trips, from mobility habit data for users as a driver. The first threshold may be predetermined. In one embodiment, the first threshold may be equal to the strong habit threshold used for grouping mobility habit data. That is, trips which match the riding requirement and correspond to strong habits may be regarded as target trips. Table 2 shows the searched target trips which match the riding requirement of the user as the passenger “from work to gym at 16:30” and have habit values above the strong habit threshold which is equal to 0.30.

TABLE 2
Searched target trips for the user as the passenger

| | | Habit | Time | Transport modality |
|---|---|---|---|---|
| User | Trip | value | information | information |
| A | Work→Gym | 0.38 | 16:30 ± 17 min | driver |
| B | Work→Gym | 0.36 | 16:05 ± 31 min | driver |
| C | Work→Gym | 0.31 | 16:43 ± 29 min | driver |

Next, in step 304, the riding requirement is sent to users as the driver related to the target trip. For example, the riding requirement of the user as the passenger “from work to gym at 16:30” is sent to the users as the drivers A, B, and C.

Next, in step 305, the users as the driver are recommended to the user as the passenger after confirmation information is received from the users as the driver.

With this embodiment, the driver resources are recommended to the user as the passenger according to mobility habit data. This mobility habit based recommendation is more efficient and more accurate compared to ride sharing recommendations in the prior art where the mobility habit data of users is not used.

In one embodiment, if the confirmation information is not received from the users as the driver in a predetermined time period, trips which match the riding requirement and have habit values above a second threshold and below the first threshold are further searched as target trips from mobility habit data for users as the driver, according to the received riding requirement. The second threshold may be predetermined. In one embodiment, the second threshold may be smaller than the first threshold. In one embodiment, the second threshold may be equal to the weak habit threshold used for grouping mobility habit data. That is, trips which match the riding requirement and correspond to medium habits may be regarded as target trips.

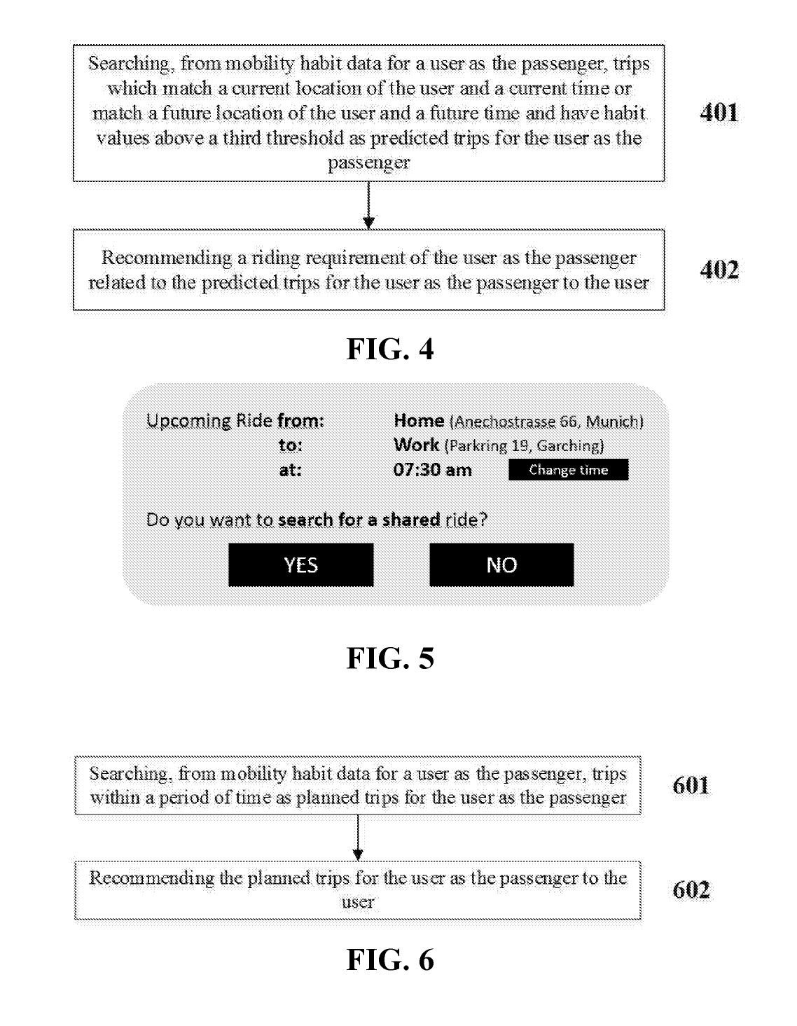

Referring now to FIG. 4, there is shown a flowchart of a computer implemented method for recommending car resources for a user as a passenger according to mobility habits for the user in accordance with an exemplary embodiment of the present disclosure. With this embodiment, a riding requirement of a user as the passenger is intelligently recommended to the user as the passenger.

As shown in FIG. 4, in step 401, trips are searched from mobility habit data for a user as the passenger as predicted trips for the user as the passenger, wherein the trips match a current location of the user and a current time or match a future location of the user and a future time and have habit values above a third threshold. The third threshold may be predetermined. In one embodiment, the third threshold may be equal to the strong habit threshold.

Next, in step 402, a riding requirement of the user as the passenger related to the predicted trips for the user as the passenger is recommended to the user.

For example, a current riding requirement may be recommended to the user as the passenger. As shown in FIG. 2 (a), if the user as the passenger is currently at home, and the current time is 07:30, the riding requirement of “from home to work at 07:30” may be recommended to the user as the passenger as required by the user according to the mobility habit data for the user. Similarly, an upcoming riding requirement may be recommended to the user as the passenger. As shown in FIG. 2 (a), if the current time is 15:00, the riding requirement of “from work to gym at 16:48” may also be recommended to the user as an upcoming trip.

FIG. 5 illustrates a user interface of a riding requirement recommendation for a user as a passenger in accordance with an exemplary embodiment of the present disclosure. The riding requirement of “from home to work at 07:30” is generated and recommended to the user as the passenger. In this case, the user does not need to input a riding requirement including a start, a destination and a departure time manually. Instead, he only needs to answer the question “Do you want to search for a shared ride?” by clicking the button “Yes” or “No”. In one embodiment, the departure time of the riding requirement may be changed by the user as the passenger.

With this embodiment, instead of inputting a riding requirement by the user as the passenger himself, the riding requirement is intelligently predicted from the mobility habit data for the user as the passenger, and is automatically recommended to the user. The embodiment provides the opportunity for the user as the passenger to search for a shared ride by just one click or rather touch, thus manual and time-consuming input of personal data such as the riding requirement is omitted, which is especially beneficial to ride sharing services for short distances.

In one embodiment, the riding requirement may be automatically pushed onto the mobile phone, tablet, as well as a computer of the user as the passenger in the following forms of a standalone application, and being integrated into other applications such as part of a digital assistant (Siri, Google Now, Microsoft Cortana and the like), part of a social network (Facebook, Google+ and the like), or chatting applications (WeChat, Whatsapp and the like).

In one embodiment, the riding requirement of the user as the passenger related to the predicted trips for the user as the passenger may be recommended to the user regularly.

Referring now to FIG. 6, there is shown a flowchart of a computer implemented method for recommending car resources for a user as a passenger according to mobility habits for the user in accordance with an exemplary embodiment of the present disclosure. With this embodiment, planned trips for a user as the passenger are recommended to the user as the passenger.

As shown in FIG. 6, in step 601, trips within a period of time are searched from mobility habit data for a user as the passenger, as planned trips for the user as the passenger.

Next, in step 602, the planned trips for the user as the passenger are recommended to the user.

In this embodiment, planned trips do not only include the next most likely trip, but include trips farther into the future. For example, the period of time may be one day, thus planned trips for one day are recommended to the user as the passenger. For example, if the period of time is one day, all of the seven trips as shown in FIG. 2 (a) may be regarded as planned trips for the user as the passenger. Accordingly, what a user as a passenger will do during one day is recommended to the user, which will support the user as the passenger in planning his day.

In one embodiment, the mobility habit data for the user as the passenger may be sorted by time information corresponding to trips for the user. For example, as illustrated in FIG. 2 (a), the mobility habit data is sorted in chronological order. Accordingly, the planned trips recommended to the user as the passenger are sorted by time information, thus makes it easier for the user as the passenger to grasp an overview of his day.

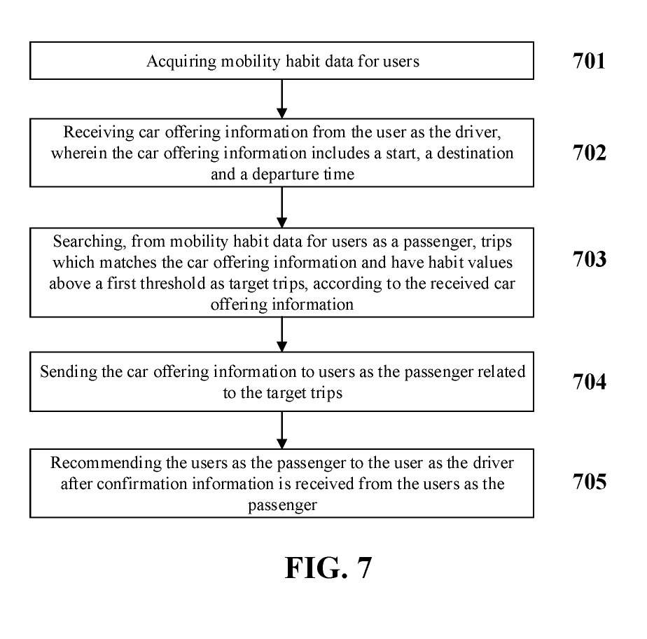

Referring now to FIG. 7, there is shown a flowchart of a computer implemented method for recommending passenger resources for a user as a driver according to mobility habits for the user in accordance with an exemplary embodiment of the present disclosure.

As shown in FIG. 7, in step 701, mobility habit data for users is acquired according to the computer implemented method for generating mobility habit data for a user in accordance with the aforementioned exemplary embodiments of the present disclosure. Mobility habit data for a user may comprise a trip including a start and a destination, time information corresponding to the trip, a habit value of the trip, and transport modality information indicating the user as a driver or a passenger as illustrated in FIGS. 2 (a) and (b).

Next, in step 702, car offering information is received from the user as the driver, wherein the car offering information includes a start, a destination and a departure time. For example, the car offering information of the user as the driver may be “from work to gym at 16:30”. The car offering information may be input by the user as the driver according to his current or future car offering conditions and sent via his mobile phone, tablet as well as other portable equipment, or applications integrated in his car, and so on.

Next, in step 703, according to the received car offering information, trips which match the car offering information and have habit values above a first threshold are searched as target trips, from mobility habit data for users as a passenger. The first threshold may be predetermined. In one embodiment, the first threshold may be equal to the strong habit threshold used for grouping mobility habit data. That is, trips which match the riding requirement and correspond to strong habits may be regarded as target trips. Table 3 shows the searched target trips which match the car offering information of the user as the driver “from work to gym at 16:30” and have habit values above the strong habit threshold which is equal to 0.30.

TABLE 3
Searched target trips for the user as the driver

| | | Habit | Time | Transport modality |
|---|---|---|---|---|
| User | Trip | value | information | information |
| D | Work→Gym | 0.39 | 16:25 ± 14 min | passenger |
| E | Work→Gym | 0.35 | 16:21 ± 34 min | passenger |
| F | Work→Gym | 0.34 | 16:48 ± 34 min | passenger |

Next, in step 704, the car offering information is sent to users as the passenger related to the target trip. For example, the car offering information of the user as the driver “from work to gym at 16:30” is sent to the passengers D, E, and F.

Next, in step 705, the users as the passenger are recommended to the user as the driver after confirmation information is received from the users as the passenger.

With this embodiment, the passenger resources are recommended to the user as the driver according to mobility habit data. This mobility habit based recommendation is more efficient and more accurate compared to ride sharing recommendations in the prior art where the mobility habit data of users is not used.

In one embodiment, if the confirmation information is not received from the users as the passenger in a predetermined time period, trips which match the car offering information and have habit values above a second threshold and below the first threshold are further searched as target trips from mobility habit data for users as a passenger, according to the received car offering information. The second threshold may be predetermined. In one embodiment, the second threshold may be smaller than the first threshold. In one embodiment, the second threshold may be equal to the weak habit threshold used for grouping mobility habit data. That is, trips which match the car offering information and correspond to medium habits may be regarded as target trips.

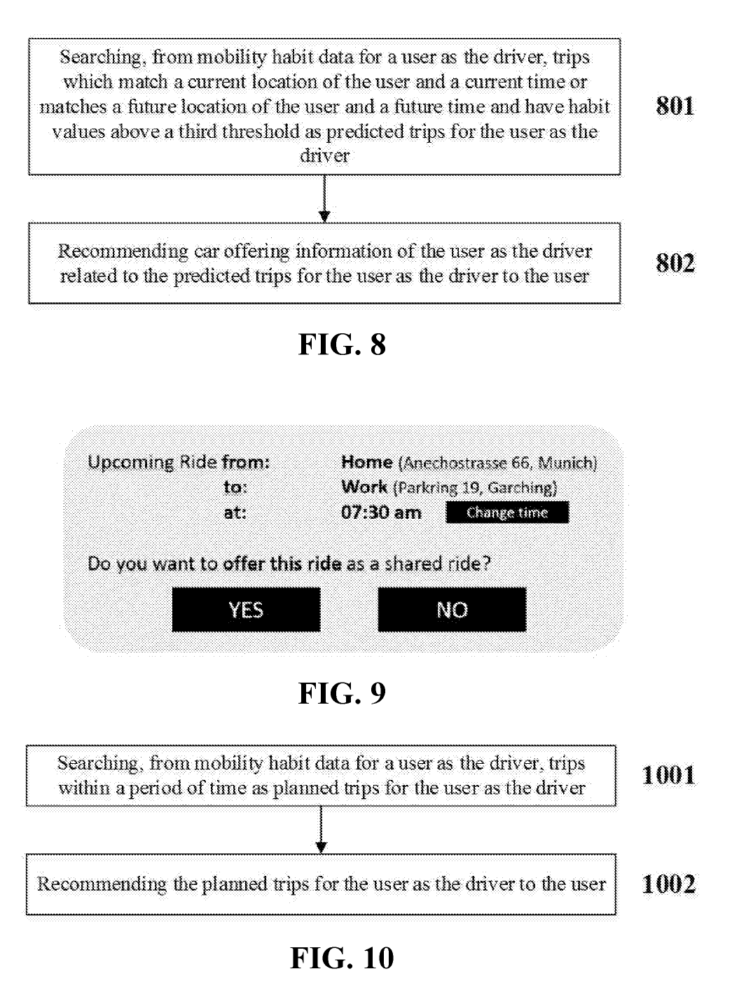

Referring now to FIG. 8, there is shown a flowchart of a computer implemented method for recommending passenger resources for a user as a driver according to mobility habits for the user in accordance with an exemplary embodiment of the present disclosure. With this embodiment, car offering information of a user as the driver is intelligently recommended to the user as the driver.

As shown in FIG. 8, in step 801, trips are searched from mobility habit data for a user as the driver as predicted trips for the user as the driver, wherein the trips match a current location of the user and a current time or match a future location of the user and a future time and have habit values above a third threshold.

Next, in step 802, car offering information of the user as the driver related to the predicted trips for the user as the driver is recommended to the user.

For example, a current car offering information may be recommended to the user as the driver. As shown in FIG. 2 (b), if the user as the driver is currently at home, and the current time is 08:00, the car offering information of “from home to work at 08:00” may be recommended to the user as the passenger as required by the user according to the mobility habit data for the user. Similarly, an upcoming car offering information may be recommended to the user as the passenger. As shown in FIG. 2 (b), if the current time is 15:00, the riding requirement of “from work to gym at 16:05” may also be recommended to the user as an upcoming trip.

FIG. 9 illustrates a user interface of a car offering information recommendation for a user as a driver in accordance with an exemplary embodiment of the present disclosure. The car offering information of “from home to work at 07:30 am” is generated and recommended to the user as the driver. In this case, the user does not need to input car offering information including a start, a destination and a departure time manually. Instead, he only needs to answer the question “Do you want to offer this ride as a shared ride?” by clicking the button “Yes” or “No”. In one embodiment, the departure time of the car offering information may be changed by the user as the driver.

With this embodiment, instead of inputting car offering information by the user as the driver himself, the car offering information is intelligently predicted from the mobility habit data for the user as the driver, and is automatically recommended to the user. The embodiment provides the opportunity for the user as the driver to offer a shared ride by just one click or rather touch, thus manual and time-consuming input of personal data such as the car offering information is omitted, which is especially beneficial to ride sharing services for short distances.

In one embodiment, the car offering information may be automatically pushed onto the mobile phone, tablet, a computer as well as a car of the user as the driver in the following forms of a standalone application, an application in the headunit of a car, and being integrated into other applications such as part of a digital assistant (Siri, Google Now, Microsoft Cortana and the like), part of a social network (Facebook, Google+ and the like), or chatting applications (WeChat, Whatsapp and the like).

In one embodiment, the car offering information of the user as the driver related to the predicted trips for the user as the driver may be recommended to the user regularly.

Referring now to FIG. 10, there is shown a flowchart of a computer implemented method for recommending passenger resources for a user as a driver according to mobility habits for the user in accordance with an exemplary embodiment of the present disclosure. With this embodiment, planned trips for a user as the driver are recommended to the user as the driver.

As shown in FIG. 10, in step 1001, trips within a period of time is searched from mobility habit data for a user as the driver, as planned trips for the user as the driver.

Next, in step 1002, the planned trips for the user as the driver are recommended to the user.

In this embodiment, planned trips do not only include the next most likely trip, but include trips farther into the future. For example, the period of time may be one day, thus planned trips for one day are recommended to the user as the driver. For example, if the period of time is one day, all of the seven trips as shown in FIG. 2 (b) may be regarded as planned trips for the user as the driver. Accordingly, what a user as a driver will do during one day is recommended to the user, which will support the user as the driver in planning his day.

In one embodiment, the mobility habit data for the user as the driver may be sorted by time information corresponding to trips for the user. For example, as illustrated in FIG. 2 (b), the mobility habit data is sorted in chronological order. Accordingly, the planned trips recommended to the user as the driver are sorted by time information, thus makes it easier for the user as the driver to grasp an overview of his day.

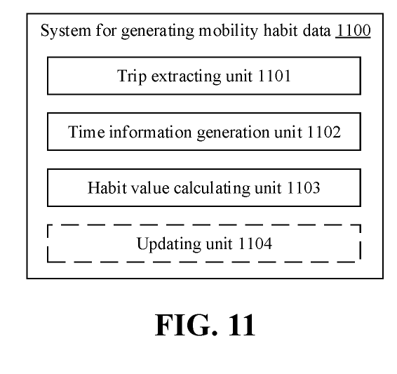

FIG. 11 illustrates a functional block diagram of a system 1100 for generating mobility habit data for a user in accordance with an exemplary embodiment of the present disclosure. All the functional blocks of the system 1100 (various units included in the system 1100, whether shown or not shown in the figure) may be implemented by hardware, software, or a combination of hardware and software to carry out the principles of the invention. It is understood by those skilled in the art that the functional blocks described in FIG. 11 may be combined or separated into sub-blocks to implement the principles of the invention as described above. Therefore, the description herein may support any possible combination or separation or further definition of the functional blocks described herein.

As shown in FIG. 11, according to an exemplary embodiment of the present disclosure, the system 1100 for generating mobility habit data for a user may comprise: a trip extracting unit 1101, a time information generating unit 1102, and a habit value calculating unit 1103. The trip extracting unit 1101 may be configured to extract a trip including a start and a destination from location data of the user, wherein paths with the same start and the same destination are clustered into one trip. The trip extracting unit 1102 may be configured to generate time information corresponding to the trip, according to time data corresponding to the paths clustered into the trip, wherein the time information includes a range of departure time. The time information generation unit 1103 may be configured to calculate a frequency of occurrences for one trip within a predetermined time period as a habit value of the trip for the user. The trip including the start and the destination, the time information corresponding to the trip, the habit value of the trip, and transport modality information indicating the user as a driver or a passenger are used together as the mobility habit data for the user.

Therefore, the mobility habit data for a user may be used for recommending car/passenger resources for the user.

In one embodiment, the system 1100 for generating mobility habit data for a user may further comprise an updating unit 1104 as shown in FIG. 11. The updating unit 1104 may be configured to update the mobility habit data for the user based on the existing mobility habit data for the user and new transport modality information, location data and time data corresponding to the location data.

In one embodiment, two trips may be clustered into one trip if differences between the starts and the destinations of the two trips are within a predetermined range. In some cases, the localization measures are inaccurate, causing the acquired location data varying even when a person does not move. If differences between the starts and the destinations of two trips are within a predetermined range, the two trips are clustered into one trip. Therefore, the inaccuracy due to localization measures may be decreased.

In one embodiment, the mobility habit data for the user may be grouped by the habit values of trips for the user. For example, as illustrated in FIGS. 2 (a) and (b), the mobility habit data is grouped into strong habits with habit values above a strong habit threshold, medium habits with habit values above a weak habit threshold and below the strong habit threshold, and weak habits with habit values below the weak habit threshold. The strong habit threshold is larger than the weak habit threshold.

In one embodiment, the mobility habit data for the user may be sorted by time information corresponding to trips for the user. For example, as illustrated in FIGS. 2 (a) and (b), the mobility habit data is sorted in chronological order.

In one embodiment, the habit value calculating unit 1103 may be further configured that the predetermined time period is only calculated for workdays or holidays. Since the regularity of most persons' mobility strongly varies depending on the current day being a workday or a holiday, it is possible to make the calculated habit value conform with the user's actual habit more accurate by using the predetermined time period only calculated for workdays or holidays.

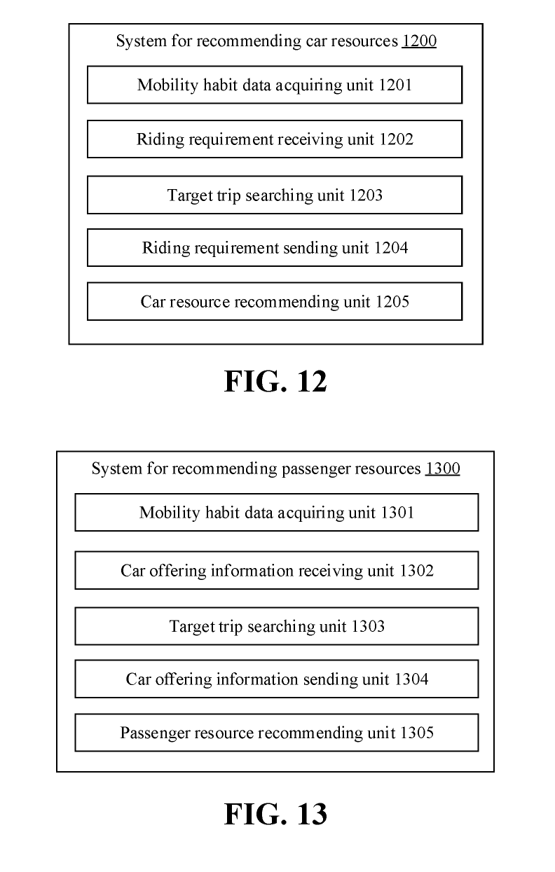

FIG. 12 illustrates a functional block diagram of a system 1200 for recommending car resources for a user as a passenger in accordance with an exemplary embodiment of the present disclosure. All the functional blocks of the system 1200 (various units included in the system 1200, whether shown or not shown in the figure) may be implemented by hardware, software, or a combination of hardware and software to carry out the principles of the invention. It is understood by those skilled in the art that the functional blocks described in FIG. 12 may be combined or separated into sub-blocks to implement the principles of the invention as described above. Therefore, the description herein may support any possible combination or separation or further definition of the functional blocks described herein.

As shown in FIG. 12, according to an exemplary embodiment of the present disclosure, the system 1200 for recommending car resources for a user as a passenger may comprise: a mobility habit data acquiring unit 1201, a riding requirement receiving unit 1202, a target trip searching unit 1203, a requirement information sending unit 1204, and a car resource recommending unit 1205.

The mobility habit data acquiring unit 1201 may be configured to acquire mobility habit data for users generated according to the system 1100 for generating mobility habit data for a user. Mobility habit data for a user may comprise a trip including a start and a destination, time information corresponding to the trip, a habit value of the trip, and transport modality information indicating the user as a driver or a passenger.

The riding requirement receiving unit 1202 may be configured to receive a riding requirement from the user as the passenger, wherein the riding requirement includes a start, a destination and a departure time. For example, the riding requirement of the user as the passenger may be “from home to work at 07:30”. The riding requirement may be input by the user as the passenger according to his current or future riding conditions and sent via his mobile phone, tablet as well as other portable equipment, and so on.

The target trip searching unit 1203 may be configured to search, from mobility habit data for users as a driver, trips which match the riding requirement and have habit values above a first threshold as target trips, according to the received riding requirement. The first threshold may be predetermined. In one embodiment, the first threshold may be equal to the strong habit threshold used for grouping mobility habit data. That is, trips which match the riding requirement and correspond to strong habits may be regarded as target trips.

The requirement information sending unit 1204 may be configured to send requirement information to users as the driver related to the target trips.

The car resource recommending unit 1205 may be configured to recommend the users as the driver to the user as the passenger after confirmation information is received from the users as the driver.

With this embodiment, the driver resources are recommended to the user as the passenger according to mobility habit data. This mobility habit based recommendation is more efficient and more accurate compared to ride sharing recommendations in the prior art where mobility habit data of users is not used.

In one embodiment, the target trip searching unit 1203 may be further configured that if the confirmation information is not received from the users as the driver in a predetermined time period, trips which match the riding requirement and have habit values above a second threshold and below the first threshold are further searched as target trips from mobility habit data for users as a driver, according to the received riding requirement. The second threshold may be predetermined. In one embodiment, the second threshold may be smaller than the first threshold. In one embodiment, the second threshold may be equal to the weak habit threshold used for grouping mobility habit data. That is, trips which match the riding requirement and correspond to medium habits may be regarded as target trips.

In one embodiment, the system 1200 for recommending car resources for a user as a passenger may further comprise a trip predicting unit and a riding requirement recommending unit.

The trip predicting unit may be configured to search, from mobility habit data for a user as the passenger, trips which match a current location of the user and a current time or match a future location of the user and a future time and have habit values above a third threshold as predicted trips for the user as the passenger. The third threshold may be predetermined. In one embodiment, the third threshold may be equal to the strong habit threshold. The riding requirement recommending unit may be configured to recommend a riding requirement of the user as the passenger related to the predicted trips for the user as the passenger to the user.

In this embodiment, instead of inputting a riding requirement by the user as the passenger himself, the riding requirement is intelligently predicted from the mobility habit data for the user as the passenger, and is automatically recommended to the user. With this embodiment, manual and time-consuming input of personal data such as the riding requirement is omitted, which is especially beneficial to ride sharing services for short distances. A user interface of such riding requirement recommendation for a user as a passenger according to this embodiment is illustrated in FIG. 5. This riding requirement recommendation for a user as a passenger provides the opportunity for the user as the passenger to search for a shared ride by just one click or rather touch.

In one embodiment, the trip predicting unit may be further configured that the riding requirement of the user as the passenger related to the predicted trips for the user as the passenger is recommended to the user regularly.

In one embodiment, the system 1200 for recommending car resources for a user as a passenger may further comprise a trip planning unit and a planned trip recommending unit. With this embodiment, planned trips for a user as the passenger are recommended to the user as the passenger.

The trip planning unit may be configured to search, from mobility habit data for a user as the passenger, trips within a period of time as planned trips for the user as the passenger. The planned trip recommending unit may be configured to recommend the planned trips for the user as the passenger to the user.

In this embodiment, planned trips do not only include the next most likely trip, but include trips farther into the future. For example, the period of time may be one day, thus planned trips for one day is recommended to the user as the passenger. For example, if the period of time is one day, all of the seven trips as shown in FIG. 2 (a) may be regarded as planned trips for the user as the passenger. Accordingly, what a user as a passenger will do during one day is recommended to the user, which will support the user as the passenger in planning his day.

In one embodiment, the mobility habit data for the user may be sorted by time information corresponding to trips for the user. For example, as illustrated in FIG. 2 (a), the mobility habit data is sorted in chronological order. Accordingly, the planned trips recommended to the user as the passenger are sorted by time information, thus makes it easier for the user as the passenger to grasp an overview of his day.

FIG. 13 shows a functional block diagram of a system 1300 for recommending passenger resources for a user as a driver in accordance with an exemplary embodiment of the present disclosure. All the functional blocks of the system 1300 (various units included in the system 1300, whether shown or not shown in the figure) may be implemented by hardware, software, or a combination of hardware and software to carry out the principles of the invention. It is understood by those skilled in the art that the functional blocks described in FIG. 13 may be combined or separated into sub-blocks to implement the principles of the invention as described above. Therefore, the description herein may support any possible combination or separation or further definition of the functional blocks described herein.

As shown in FIG. 13, according to an exemplary embodiment of the present disclosure, the system 1300 for recommending passenger resources for a user as a driver may comprise: mobility habit data acquiring unit 1301, a car offering information receiving unit 1302, a target trip searching unit 1303, a car offering information sending unit 1304, and a passenger resource recommending unit 1305.

The mobility habit data acquiring unit 1301 may be configured to acquire mobility habit data for users generated according to the system 1100 for generating mobility habit data for a user. Mobility habit data for a user may comprise a trip including a start and a destination, time information corresponding to the trip, a habit value of the trip, and transport modality information indicating the user as a driver or a passenger.

The car offering information receiving unit 1302 may be configured to receive car offering information from the user as the driver, wherein the car offering information includes a start, a destination and a departure time. For example, the car offering information of the user as the driver may be “from home to work at 07:30”. The car offering information may be input by the user as the driver according to his current or future car offering conditions and sent via his mobile phone, tablet as well as other portable equipment, or applications integrated in his car, and so on.

The target trip searching unit 1303 may be configured to search, from mobility habit data for users as a passenger, trips which match the car offering information and have habit values above a first threshold as target trips, according to the received car offering information. The first threshold may be predetermined. In one embodiment, the first threshold may be equal to the strong habit threshold used for grouping mobility habit data. That is, trips which match the car offering information and correspond to strong habits may be regarded as target trips.

The car offering information sending unit 1304 may be configured to send car offering information to users as the passenger related to the target trips.

The passenger resource recommending unit 1305 may be configured to recommend the users as the passenger to the user as the driver after confirmation information is received from the users as the passenger.

With this embodiment, the passenger resources are recommended to the user as the driver according to mobility habit data. This mobility habit based recommendation is more efficient and more accurate compared to ride sharing recommendations in the prior art where mobility habit data of users is not used.

In one embodiment, the target trip searching unit 1303 may be further configured that if the confirmation information is not received from users as the passenger in a predetermined time period, trips which match the car offering information and have habit values above a second threshold and below the first threshold are further searched as target trips from the mobility habit data for users as the passenger, according to the received car offering information. The second threshold may be predetermined. In one embodiment, the second threshold may be smaller than the first threshold. In one embodiment, the second threshold may be equal to the weak habit threshold used for grouping mobility habit data. That is, trips which match the car offering information and correspond to medium habits may be regarded as target trips.

In one embodiment, the system 1300 for recommending passenger resources for a user as a driver may further comprise a trip predicting unit and a car offering information recommending unit.

The trip predicting unit may be configured to search, from mobility habit data for a user as the driver, trips which match a current location of the user and a current time or match a future location of the user and a future time and have habit values above a third threshold as predicted trips for the user as the driver. The third threshold may be predetermined. In one embodiment, the third threshold may be equal to the strong habit threshold. The car offering information recommending unit may be configured to recommend car offering information of the user as the driver related to the predicted trips for the user as the driver to the user.

In this embodiment, instead of inputting car offering information by the user as the driver himself, the car offering information is intelligently predicted from the mobility habit data for the user as the driver, and is automatically recommended to the user. With this embodiment, manual and time-consuming input of personal data such as the car offering information is omitted, which is especially beneficial to ride sharing services for short distances. A user interface of such car offering information recommendation for a user as a driver according to this embodiment is illustrated in FIG. 9. This car offering information recommendation for a user as a driver provides the opportunity for the user as the driver to search for a shared ride by just one click or rather touch.

The trip predicting unit may be further configured that the car offering information of the user as the driver related to the predicted trips for the user as the driver is recommended to the user regularly.

In one embodiment, the system 1300 for recommending passenger resources for a user as a driver may further comprise a trip planning unit and a planned trip recommending unit.

The trip planning unit may be configured to search, from mobility habit data for a user as the driver, trips within a period of time as planned trips for the user as the driver. The planned trip recommending unit may be configured to recommend the planned trips for the user as the driver to the user.

In this embodiment, planned trips do not only include the next most likely trip, but include trips farther into the future. For example, the period of time may be one day, thus planned trips for one day is recommended to the user as the driver. For example, if the period of time is one day, all of the seven trips as shown in FIG. 2 (b) may be regarded as planned trips for the user as the driver. Accordingly, what a user as a driver will do during one day is recommended to the user, which will support the user as the driver in planning his day.

In one embodiment, the mobility habit data for the user as the driver is sorted by time information corresponding to trips for the user. For example, as illustrated in FIG. 2 (b), the mobility habit data is sorted in chronological order. Accordingly, the planned trips recommended to the user as the driver are sorted by time information, thus makes it easier for the user as the driver to grasp an overview of his day.

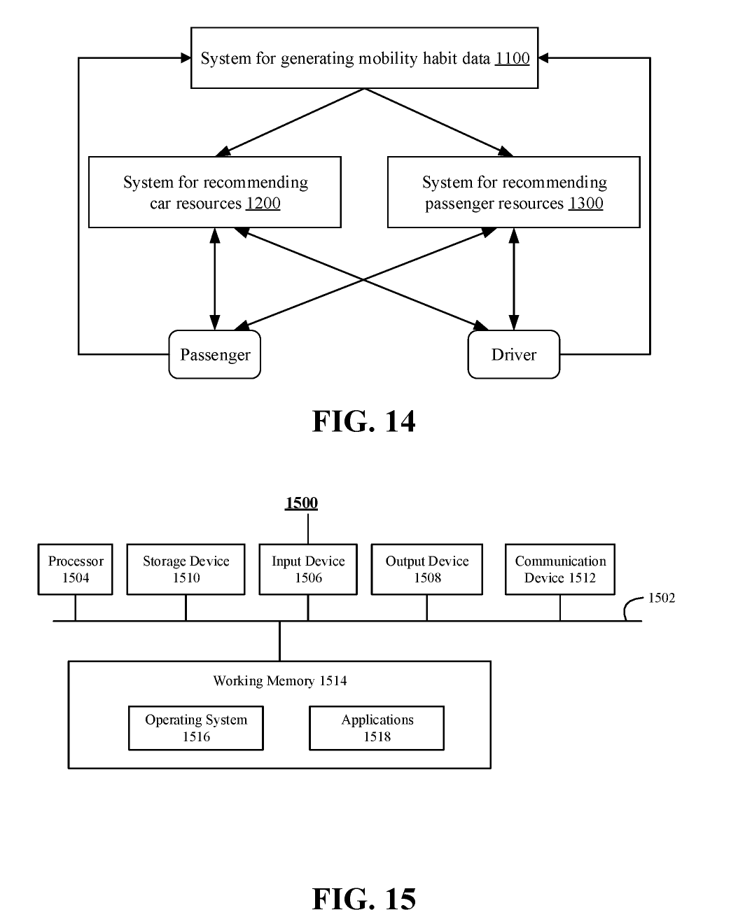

FIG. 14 shows a schematic system for recommending car/passenger resources based on mobility habit data in accordance with an exemplary embodiment of the present disclosure.

As shown in FIG. 14, the system 1100 for generating mobility habit data obtains from a user (a driver or a passenger), location data of the user, time data corresponding to the location data and transport modality information indicating the user as a driver or a passenger. Mobility habit data for the user is generated by the system 1100 and provided to the system 1200 for recommending a car resource and system 1300 for recommending passenger resources. The system 1200 recommends car resources for a user as a passenger according to the mobility habit data provided from system 1000 if confirmation information is received from a user as a driver. The system 1300 recommends a passenger resource for a user as a driver according to the mobility habit data provided from system 1000 if confirmation information is received from a user as a passenger.

Furthermore, one or more embodiments of the present invention may be implemented as follows.

Solution 1: A system for generating mobility habit data for a user, comprising: a trip extracting unit, configured to extract a trip including a start and a destination from location data of the user, wherein paths with the same start and the same destination are clustered into one trip; a time information generating unit, configured to generate time information corresponding to the trip, according to time data corresponding to the paths clustered into the trip, wherein the time information includes a range of departure time; and a habit value calculating unit, configured to calculate a frequency of occurrences for one trip within a predetermined time period as a habit value of the trip for the user, wherein the trip including the start and the destination, the time information corresponding to the trip, the habit value of the trip, and transport modality information indicating the user as a driver or a passenger are used together as the mobility habit data for the user.

Solution 2: The system of Solution 1, further comprising an updating unit, configured to update the mobility habit data for the user based on the existing mobility habit data for the user and new transport modality information, location data and time data corresponding to the location data.

Solution 3: The system of Solution 1 or 2, wherein two trips are clustered into one trip if differences between the starts and the destinations of the two trips are within a predetermined range.

Solution 4: The system of Solution 1 or 2, wherein the mobility habit data for the user is grouped by the habit values of trips for the user.

Solution 5: The system of Solution 1 or 2, wherein the mobility habit data for the user is sorted by time information corresponding to trips for the user.

Solution 6: The system of Solution 1 or 2, wherein the habit value calculating unit may be further configured that the predetermined time period is only calculated for workdays or holidays.

Solution 7: A system for recommending car resources for a user as a passenger according to mobility habits for the user, comprising: a mobility habit data acquiring unit, configured to acquire mobility habit data for users generated according to the system of any one of Solutions 1 to 6; a riding requirement receiving unit, configured to receive a riding requirement from the user as the passenger, wherein the riding requirement includes a start, a destination and a departure time; a target trip searching unit, configured to search, from mobility habit data for users as a driver, trips which match the riding requirement and have habit values above a first threshold as target trips, according to the received riding requirement; a riding requirement sending unit, configured to send the riding requirement to users as the driver related to the target trips; and a car resource recommending unit, configured to recommend the users as the driver to the user as the passenger after confirmation information is received from the users as the driver.

Solution 8: The system of Solution 7, wherein the target trip searching unit is further configured to search, from the mobility habit data for users as the driver, trips which match the riding requirement and have habit values above a second threshold and below the first threshold as target trips, according to the received riding requirement, if the confirmation information is not received from the users as the driver in a predetermined time period.

Solution 9: The system of Solution 7, further comprising: a trip predicting unit, configured to search, from mobility habit data for a user as the passenger, trips which match a current location of the user and a current time or match a future location of the user and a future time and have habit values above a third threshold as predicted trips for the user as the passenger; and a riding requirement recommending unit, configured to recommend a riding requirement of the user as the passenger related to the predicted trips for the user as the passenger to the user.

Solution 10: The system of Solution 9, wherein the trip predicting unit is further configured that the riding requirement of the user as the passenger related to the predicted trips for the user as the passenger is recommended to the user regularly.

Solution 11: The system of Solution 7, further comprising: a trip planning unit, configured to search, from mobility habit data for a user as the passenger, trips within a period of time as planned trips for the user as the passenger; and a planned trip recommending unit, configured to recommend the planned trips for the user as the passenger to the user.

Solution 12: A system for recommending passenger resources for a user as a driver according to mobility habits for the user, comprising: a mobility habit data acquiring unit, configured to acquire mobility habit data for users generated according to the system of any one of Solutions 1 to 6; a car offering information receiving unit, configured to receive car offering information from the user as the driver, wherein the car offering information includes a start, a destination and a departure time; a target trip searching unit, configured to search, from mobility habit data for users as a passenger, trips which matches the car offering information and have habit values above a first threshold as target trips, according to the received car offering information; a car offering information sending unit, configured to send the car offering information to users as the passenger related to the target trips; and a passenger resource recommending unit, configured to recommend the users as the passenger to the user as the driver after confirmation information is received from the users as the passenger.

Solution 13: The system of Solution 12, wherein the target trip searching unit is further configured to search, from the mobility habit data for users as the passenger, trips which match the car offering information and have habit values above a second threshold and below the first threshold as target trips, according to the received car offering information, if the confirmation information is not received from the users as the passenger in a predetermined time period.

Solution 14: The system of Solution 12, further comprising: a trip predicting unit, configured to search, from mobility habit data for a user as the driver, trips which match a current location of the user and a current time or matches a future location of the user and a future time and have habit values above a third threshold as predicted trips for the user as the driver; and a car offering information recommending unit, configured to recommend car offering information of the user as the driver related to the predicted trips for the user as the driver to the user.

Solution 15: The system of Solution 14, wherein the trip predicting unit is further configured that the car offering information of the user as the driver related to the predicted trips for the user as the driver is recommended to the user regularly.

Solution 16: The system of Solution 12, further comprising: a trip planning unit, configured to search, from mobility habit data for a user as the driver, trips within a period of time as planned trips for the user as the driver; and a planned trip recommending unit, configured to recommend the planned trips for the user as the driver to the user.

Solution 17: A computer program product for generating mobility habit data for a user, the computer program product comprising a non-transitory computer readable medium having instructions stored thereon for, which, when executed by a processor, causing the processor to perform operations comprising: extracting a trip including a start and a destination from location data of the user, wherein paths with the same start and the same destination are clustered into one trip; generating time information corresponding to the trip, according to time data corresponding to the paths clustered into the trip, wherein the time information includes a range of departure time; and calculating a frequency of occurrences for one trip within a predetermined time period as a habit value of the trip for the user, wherein the trip including the start and the destination, the time information corresponding to the trip, the habit value of the trip, and transport modality information indicating the user as a driver or a passenger are used together as the mobility habit data for the user.

Solution 18: The computer program product of Solution 17, wherein the operations further comprise updating the mobility habit data for the user based on the existing mobility habit data for the user and new transport modality information, location data and time data corresponding to the location data.

Solution 19: The computer program product of Solution 17 or 18, wherein two trips are clustered into one trip if differences between the starts and the destinations of the two trips are within a predetermined range.

Solution 20: The computer program product of Solution 17 or 18, wherein the mobility habit data for the user is grouped by the habit values of trips for the user.

Solution 21: The computer program product of Solution 17 or 18, wherein the mobility habit data for the user is sorted by time information corresponding to trips for the user.

Solution 22: The computer program product of Solution 17 or 18, wherein the predetermined time period is only calculated for workdays or holidays.

Solution 23: A computer program product for recommending car resources for a user as a passenger according to mobility habits for the user, the computer program product comprising a non-transitory computer readable medium having instructions stored thereon for, which, when executed by a processor, causing the processor to perform operations comprising: acquiring mobility habit data for users generated according to the computer program product of any one of Solutions 17 to 22; receiving a riding requirement from the user as the passenger, wherein the riding requirement includes a start, a destination and a departure time; searching, from mobility habit data for users as the driver, trips which match the riding requirement and have habit values above a first threshold as target trips, according to the received riding requirement; sending the riding requirement to users as the driver related to the target trips; and recommending the users as the driver to the user as the passenger after confirmation information is received from the users as the driver.

Solution 24: The computer program product of Solution 23, wherein searching, from the mobility habit data for users as the driver, trips which match the riding requirement and have habit values above a second threshold and below the first threshold as target trips, according to the received riding requirement, if the confirmation information is not received from the users as the driver in a predetermined time period.

Solution 25: The computer program product of Solution 23, wherein the operations further comprise searching, from mobility habit data for a user as the passenger, trips which match a current location of the user and a current time or match a future location of the user and a future time and have habit values above a third threshold as predicted trips for the user as the passenger; and recommending a riding requirement of the user as the passenger related to the predicted trips for the user as the passenger to the user.

Solution 26: The computer program product of Solution 25, wherein the riding requirement of the user as the passenger related to the predicted trips for the user as the passenger is recommended to the user regularly.

Solution 27: The computer program product of Solution 23, wherein the operations further comprise searching, from mobility habit data for a user as the passenger, trips within a period of time as planned trips for the user as the passenger; and recommending the planned trips for the user as the passenger to the user.

Solution 28: A computer program product for recommending passenger resources for a user as a driver according to mobility habits for the user, the computer program product comprising a non-transitory computer readable medium having instructions stored thereon for, which, when executed by a processor, causing the processor to perform operations comprising: acquiring mobility habit data for users generated according to the computer program product of any one of Solutions 17 to 22; receiving car offering information of the user as the driver, wherein the car offering information includes a start, a destination and a departure time; searching, from mobility habit data for users as a passenger, trips which match the car offering information and have habit values above a first threshold as target trips, according to the received car offering information; sending the car offering information to users as the passenger related to the target trips; and recommending the users as the passenger to the user as the driver after confirmation information is received from the users as the passenger.

Solution 29: The computer program product of Solution 28, wherein searching, from the mobility habit data for users as the passenger, trips which match the car offering information and have habit values above a second threshold and below the first threshold as target trips, according to the received car offering information, if the confirmation information is not received from the users as the passenger in a predetermined time period.

Solution 30: The computer program product of Solution 28, wherein the operations further comprise searching, from mobility habit data for a user as the driver, trips which match a current location of the user and a current time or matches a future location of the user and a future time and have habit values above a third threshold as predicted trips for the user as the driver; and recommending car offering information of the user as the driver related to the predicted trips for the user as the driver to the user.

Solution 31: The computer program product of Solution 30, wherein the car offering information of the user as the driver related to the predicted trips for the user as the driver is recommended to the user regularly.

Solution 32: The computer program product of Solution 28, wherein the operations further comprise searching, from mobility habit data for a user as the driver, trips within a period of time as planned trips for the user as the driver; and recommending the planned trips for the user as the driver to the user.

Solution 33: A device for generating mobility habit data for a user, including a processor and a memory having instructions thereon, which, when executed by the processor, cause the processor to perform the operations comprising: extracting a trip including a start and a destination from location data of the user, wherein paths with the same start and the same destination are clustered into one trip; generating time information corresponding to the trip, according to time data corresponding to the paths clustered into the trip, wherein the time information includes a range of departure time; and calculating a frequency of occurrences for one trip within a predetermined time period as a habit value of the trip for the user, wherein the trip including the start and the destination, the time information corresponding to the trip, the habit value of the trip, and transport modality information indicating the user as a driver or a passenger are used together as the mobility habit data for the user.

Solution 34: The device of Solution 33, wherein the operations further comprises updating the mobility habit data for the user based on the existing mobility habit data for the user and new transport modality information, location data and time data corresponding to the location data.

Solution 35: The device of Solution 33 or 34, wherein two trips are clustered into one trip if differences between the starts and the destinations of the two trips are within a predetermined range.

Solution 36: The device of Solution 33 or 34, wherein the mobility habit data for the user is grouped by the habit values of trips for the user.

Solution 37: The device of Solution 33 or 34, wherein the mobility habit data for the user is sorted by time information corresponding to trips for the user.

Solution 38: The device of Solution 33 or 34, wherein the predetermined time period is only calculated for workdays or holidays.

Solution 39: A device for recommending car resources for a user as a passenger according to mobility habits for the user, including a processor and a memory having instructions thereon, which, when executed by the processor, cause the processor to perform the method comprising: acquiring mobility habit data for users generated according to the device of any one of Solutions 33 to 38; receiving a riding requirement from the user as the passenger, wherein the riding requirement includes a start, a destination and a departure time; searching, from mobility habit data for users as the driver, trips which match the riding requirement and have habit values above a first threshold as target trips, according to the received riding requirement; sending the riding requirement to users as the driver related to the target trips; and recommending the users as the driver to the user as the passenger after confirmation information is received from the users as the driver.

Solution 40: The device of Solution 39, wherein searching, from the mobility habit data for users as the driver, trips which match the riding requirement and have habit values above a second threshold and below the first threshold as target trips, according to the received riding requirement, if the confirmation information is not received from the users as the driver in a predetermined time period.

Solution 41: The device of Solution 39, wherein the operation further comprises searching, from mobility habit data for a user as the passenger, trips which match a current location of the user and a current time or match a future location of the user and a future time and have habit values above a third threshold as predicted trips for the user as the passenger; and recommending a riding requirement of the user as the passenger related to the predicted trips for the user as the passenger to the user.

Solution 42: The device of Solution 41, wherein the riding requirement of the user as the passenger related to the predicted trips for the user as the passenger is recommended to the user regularly.

Solution 43: The device of Solution 39, wherein the method further comprises searching, from mobility habit data for a user as the passenger, trips within a period of time as planned trips for the user as the passenger; and recommending the planned trips for the user as the passenger to the user.

Solution 44: A device for recommending passenger resources for a user as a driver according to mobility habits for the user, including a processor and a memory having instructions thereon, which, when executed by the processor, cause the processor to perform the method comprising: acquiring mobility habit data for users generated according to the device of any one of Solutions 33 to 38; receiving car offering information of the user as the driver, wherein the car offering information includes a start, a destination and a departure time; searching, from mobility habit data for users as a passenger, trips which match the car offering information and have habit values above a first threshold as target trips, according to the received car offering information; sending the car offering information to users as the passenger related to the target trips; and recommending the users as the passenger to the user as the driver after confirmation information is received from the users as the passenger.

Solution 45: The device of Solution 44, wherein searching, from the mobility habit data for users as the passenger, trips which match the car offering information and have habit values above a second threshold and below the first threshold as target trips, according to the received car offering information, if the confirmation information is not received from the users as the passenger in a predetermined time period.

Solution 46: The device of Solution 44, wherein the method further comprises searching, from mobility habit data for a user as the driver, trips which match a current location of the user and a current time or matches a future location of the user and a future time and have habit values above a third threshold as predicted trips for the user as the driver; and recommending car offering information of the user as the driver related to the predicted trips for the user as the driver to the user.

Solution 47: The device of Solution 46, wherein the car offering information of the user as the driver related to the predicted trips for the user as the driver is recommended to the user regularly.

Solution 48: The device of Solution 44, wherein the method further comprise searching, from mobility habit data for a user as the driver, trips within a period of time as planned trips for the user as the driver; and recommending the planned trips for the user as the driver to the user.

FIG. 15 illustrates a general hardware environment where the present disclosure is applicable in accordance with an exemplary embodiment of the present disclosure.

With reference to FIG. 15, a computing device 1500, which is an example of the hardware device that may be applied to the aspects of the present disclosure, will now be described. The computing device 1500 may be any machine configured to perform processing and/or calculations, may be but is not limited to a work station, a server, a desktop computer, a laptop computer, a tablet computer, a personal data assistant, a smart phone, an on-vehicle computer or any combination thereof. The aforementioned system 1100, system 1200, and system 1300 may be wholly or at least partially implemented by the computing device 1500 or a similar device or system.

The computing device 1500 may comprise elements that are connected with or in communication with a bus 1502, possibly via one or more interfaces. For example, the computing device 1500 may comprise the bus 1502, and one or more processors 1504, one or more input devices 1506 and one or more output devices 1508. The one or more processors 1504 may be any kinds of processors, and may comprise but are not limited to one or more general-purpose processors and/or one or more special-purpose processors (such as special processing chips). The input devices 1506 may be any kinds of devices that can input information to the computing device, and may comprise but are not limited to a mouse, a keyboard, a touch screen, a microphone and/or a remote control. The output devices 1508 may be any kinds of devices that can present information, and may comprise but are not limited to display, a speaker, a video/audio output terminal, a vibrator and/or a printer. The computing device 1500 may also comprise or be connected with non-transitory storage devices 1510 which may be any storage devices that are non-transitory and can implement data stores, and may comprise but are not limited to a disk drive, an optical storage device, a solid-state storage, a floppy disk, a flexible disk, hard disk, a magnetic tape or any other magnetic medium, a compact disc or any other optical medium, a ROM (Read Only Memory), a RAM (Random Access Memory), a cache memory and/or any other memory chip or cartridge, and/or any other medium from which a computer may read data, instructions and/or code. The non-transitory storage devices 1510 may be detachable from an interface. The non-transitory storage devices 1510 may have data/instructions/code for implementing the methods and steps which are described above. The computing device 1500 may also comprise a communication device 1512. The communication device 1512 may be any kinds of device or system that can enable communication with external apparatuses and/or with a network, and may comprise but are not limited to a modem, a network card, an infrared communication device, a wireless communication device and/or a chipset such as a Bluetooth™ device, 1302.11 device, WiFi device, WiMax device, cellular communication facilities and/or the like.

The bus 1502 may include but is not limited to Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Particularly, for an on-vehicle device, the bus 1502 may also include a Controller Area Network (CAN) bus or other architectures designed for application on an automobile.

The computing device 1500 may also comprise a working memory 1514, which may be any kind of working memory that may store instructions and/or data useful for the working of the processor 1504, and may comprise but is not limited to a random access memory and/or a read-only memory device.

Software elements may be located in the working memory 1514, including but are not limited to an operating system 1516, one or more application programs 1518, drivers and/or other data and codes. Instructions for performing the methods and steps described in the above may be comprised in the one or more application programs 1518, and the units of the aforementioned system 1100, system 1200, and system 1300 may be implemented by the processor 1504 reading and executing the instructions of the one or more application programs 1518. For example, trip extracting unit 1101 of the aforementioned system 1100 may, for example, be implemented by the processor 1504 when executing an application 1518 having instructions to perform the step 101. In addition, other units of the aforementioned system 1100 may, for example, be implemented by the processor 1504 when executing an application 1518 having instructions to perform one or more of the aforementioned respective steps. Units of the aforementioned system 1200 and system 1300 may also, for example, be implemented by the processor 1504 when executing an application 1518 having instructions to perform one or more of the aforementioned respective steps. The executable codes or source codes of the instructions of the software elements may be stored in a non-transitory computer-readable storage medium, such as the storage device (s) 1510 described above, and may be read into the working memory 1514 possibly with compilation and/or installation. The executable codes or source codes of the instructions of the software elements may also be downloaded from a remote location.

It should also be appreciated that variations may be made in accordance with specific requirements. For example, customized hardware might also be used, and/or particular elements might be implemented in hardware, software, firmware, middleware, microcode, hardware description languages, or any combination thereof. Further, connection to other computing devices such as network input/output devices may be employed. For example, some or all of the disclosed methods and devices may be implemented by programming hardware (for example, a programmable logic circuitry including field-programmable gate arrays (FPGA) and/or programmable logic arrays (PLA) with an assembler language or a hardware programming language (such as VERILOG, VHDL, C++) by using the logic and algorithm according to the present disclosure.

Those skilled in the art may clearly know from the above embodiments that the present disclosure may be implemented by software with necessary hardware, or by hardware, firmware and the like. Based on such understanding, the embodiments of the present disclosure may be embodied in part in a software form. The computer software may be stored in a readable storage medium such as a floppy disk, a hard disk, an optical disk or a flash memory of the computer. The computer software comprises a series of instructions to make the computer (e.g., a personal computer, a service station or a network terminal) execute the method or a part thereof according to respective embodiment of the present disclosure.

Although aspects of the present disclosures have been described by far with reference to the drawings, the methods, systems, computer program products and devices described above are merely exemplary examples, and the scope of the present invention is not limited by these aspects, but is only defined by the appended claims and equivalents thereof. Various elements may be omitted or may be substituted by equivalent elements. In addition, the steps may be performed in an order different from what is described in the present disclosures. Furthermore, various elements may be combined in various manners. What is also important is that as the technology evolves, many of the elements described may be substituted by equivalent elements which emerge after the present disclosure.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A computer implemented method for generating mobility habit data for a user, comprising:
extracting a trip, including a start and a destination, from location data of the user, wherein paths with the same start and the same destination are clustered into the trip;
generating time information corresponding to the trip, according to time data corresponding to the paths clustered into the trip, wherein the time information includes a range of departure time; and
calculating a frequency of occurrences for the trip within a predetermined time period as a habit value of the trip for the user,
wherein the trip, including the start and the destination, the time information corresponding to the trip, the habit value of the trip, and transport modality information indicating the user as a driver or a passenger, are combined to generate the mobility habit data for the user.

2. The computer implemented method of claim 1, further comprising:
updating the mobility habit data for the user based on existing mobility habit data for the user and new transport modality information, location data and time data corresponding to the location data.

3. The computer implemented method of claim 1, wherein
two trips are clustered into one trip if differences between the starts and the destinations of the two trips are within a predetermined range.

4. The computer implemented method of claim 2, wherein
two trips are clustered into one trip if differences between the starts and the destinations of the two trips are within a predetermined range.

5. The computer implemented method of claim 1, wherein
the mobility habit data for the user is grouped by a plurality of habit values of trips for the user.

6. The computer implemented method of claim 2, wherein
the mobility habit data for the user is grouped by a plurality of habit values of trips for the user.

7. The computer implemented method of claim 1, wherein
the mobility habit data for the user is sorted by time information corresponding to trips for the user.

8. The computer implemented method of claim 1, wherein
the predetermined time period is only calculated for workdays or holidays.

9. The computer implemented method of claim 1, further comprising:
receiving a riding requirement from the user as the passenger, wherein the riding requirement includes a start, a destination and a departure time;
searching, from mobility habit data for users as a driver, trips which match the riding requirement and have habit values above a first threshold as target trips, according to the received riding requirement;
sending the riding requirement to users as the driver related to the target trips; and
recommending the users as the driver to the user as the passenger after confirmation information is received from the users as the driver.

10. The computer implemented method of claim 9, where in
searching, from the mobility habit data for users as the driver, trips which match the riding requirement and have habit values above a second threshold and below the first threshold as target trips, according to the received riding requirement, if the confirmation information is not received from the users as the driver in a predetermined time period.

11. The computer implemented method of claim 9, further comprising:
searching, from mobility habit data for a user as the passenger, trips which match a current location of the user and a current time or match a future location of the user and a future time and have habit values above a third threshold as predicted trips for the user as the passenger; and
recommending a riding requirement of the user as the passenger related to the predicted trips for the user as the passenger to the user.

12. The computer implemented method of claim 11, wherein
the riding requirement of the user as the passenger related to the predicted trips for the user as the passenger is recommended to the user regularly.

13. The computer implemented method of claim 9, further comprising:
searching, from mobility habit data for a user as the passenger, trips within a period of time as planned trips for the user as the passenger; and
recommending the planned trips for the user as the passenger to the user.

14. The computer implemented method of claim 1, further comprising:
receiving car offering information from the user as the driver, wherein the car offering information includes a start, a destination and a departure time;
searching, from mobility habit data for users as a passenger, trips which matches the car offering information and have habit values above a first threshold as target trips, according to the received car offering information;
sending the car offering information to users as the passenger related to the target trips; and
recommending the users as the passenger to the user as the driver after confirmation information is received from the users as the passenger.

15. The computer implemented method of claim 14, wherein
searching, from the mobility habit data for users as the passenger, trips which match the car offering information and have habit values above a second threshold and below the first threshold as target trips, according to the received car offering information, if the confirmation information is not received from the users as the passenger in a predetermined time period.

16. The computer implemented method of claim 14, further comprising:
searching, from mobility habit data for a user as the driver, trips which match a current location of the user and a current time or matches a future location of the user and a future time and have habit values above a third threshold as predicted trips for the user as the driver; and
recommending car offering information of the user as the driver related to the predicted trips for the user as the driver to the user.

17. The computer implemented method of claim 16, wherein
the car offering information of the user as the driver related to the predicted trips for the user as the driver is recommended to the user regularly.

18. The computer implemented method of claim 14, further comprising:
searching, from mobility habit data for a user as the driver, trips within a period of time as planned trips for the user as the driver; and
recommending the planned trips for the user as the driver to the user.

19. A computer program product comprising a non-transitory computer readable medium having instructions stored thereon for generating mobility habit data for a user, which, when executed by a processor, cause a processor to:
extract a trip, including a start and a destination, from location data of the user, wherein paths with the same start and the same destination are clustered into the trip;
generate time information corresponding to the trip, according to time data corresponding to the paths clustered into the trip, wherein the time information includes a range of departure time; and
calculate a frequency of occurrences for the trip within a predetermined time period as a habit value of the trip for the user,
wherein the trip, including the start and the destination, the time information corresponding to the trip, the habit value of the trip, and transport modality information indicating the user as a driver or a passenger, are combined to generate the mobility habit data for the user.

20. A device including a processor and a memory having instructions thereon, which, when executed by the processor, cause the processor to:
extract a trip, including a start and a destination, from location data of the user, wherein paths with the same start and the same destination are clustered into the trip;
generate time information corresponding to the trip, according to time data corresponding to the paths clustered into the trip, wherein the time information includes a range of departure time; and
calculate a frequency of occurrences for the trip within a predetermined time period as a habit value of the trip for the user,
wherein the trip, including the start and the destination, the time information corresponding to the trip, the habit value of the trip, and transport modality information indicating the user as a driver or a passenger, are combined to generate the mobility habit data for the user.
